(19) United States
(12) Patent Application Publication
(10) Pub. No.: US 2023/0010250 A1
(43) Pub. Date: Jan. 12, 2023

(54) INSPECTION PROCEDURE FOR THE DETECTION OF FOREIGN BODIES AND/OR MATERIAL INHOMOGENEITIES

(71) Applicant: Thomas FRITSCH, Lichtenau (DE)

(72) Inventor: Thomas FRITSCH, Lichtenau (DE)

(21) Appl. No.: 17/733,836

(22) Filed: Apr. 29, 2022

(30) Foreign Application Priority Data
May 14, 2021 (DE) 10 2021 112 584.7

(51) Int. Cl. G01N 22/00; G06K 9/62

(52) U.S. Cl. CPC G01N 22/00; G06K 9/6267

(57) ABSTRACT

The present invention relates to a device for detecting foreign bodies and/or material inhomogeneities and/or on or in a production piece within a material flow of a biodegradable product or a material contaminated by a substance, at least one radiation transmitter which emits electromagnetic radiation, preferably in the microwave range, as well as at least one radiation receiver for receiving at least a part of the electromagnetic radiation emitted by the radiation transmitter, as well as at least one detection module which converts the electromagnetic radiation impinging on the radiation receiver into image data, wherein the image data are generated by an evaluation of amplitude, phase and/or frequency of the impinging electromagnetic radiation, wherein the image data can be transmitted to a transmission element in a clocked or variably requested manner. the image data being generated by an evaluation of the amplitude, phase and/or frequency of the incident electromagnetic radiation, the image data being capable of being transmitted to a transmission element in a timed or variably requested manner, the transmission element indicating in a graphic, haptic, numeric and/or acoustic manner the foreign bodies and/or the material inhomogeneities and/or on or in a production piece and/or identifying such, preferably fully automatically, and/or authorising or itself triggering appropriate measures of the respective application case.

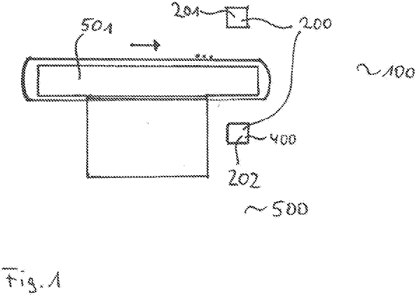

### DESCRIPTION

The present invention relates to an inspection method for detecting foreign bodies and/or material inhomogeneities and/or on or in a production piece, in particular within a material flow of an agricultural consumer product, according to the generic term of claim 1.

Furthermore, the present invention comprises a device for detecting foreign bodies and/or material inhomogeneities within a material flow of a consumable agricultural product, as well as an agricultural machine for processing and/or sorting a consumable agricultural product according to the respective headings of claims 4 and 5.

A material flow can be understood as a flow of particles, for example grains etc.. A gas flow, droplet flow and/or grain flow can be considered. A flow of particles of a certain size can also be considered. Grains can be dirt particles and/or grain (residue) grains.

An agricultural commodity can be understood in particular as a crop, for example a grain, vegetable or fruit commodity. For example, the consumable is a perishable, organic crop material.

Also, the term agricultural consumer product includes a biodegradable product or a material contaminated by a substance, where the substance and/or material differs in its physical properties that affect the electromagnetic waves.

The method described herein comprises a first step by means of which a device is provided for detecting foreign bodies and/or material inhomogeneities and/or on or in a production piece within a material flow of a consumable agricultural product.

A foreign body can be understood as such a body within the material flow of the consumable which has a density which is at least 10%, preferably more than 20% greater or smaller than an average density of the consumable. Alternatively or additionally, a surface shape can also be used as a measurand (instead of or in addition to the density).

For the purposes of the invention, density is understood to be a value that can be determined by the invention perceptible environmental influences of the measured material flow. Thus, the physical properties that have an influence on the electromagnetic waves through the material are described.

For the purposes of the invention, an average density of a consumer product is understood to be such a density value which, for example, stands for a corresponding grade of the consumer product. Each grade can therefore be assigned one, preferably exactly one, average density value.

In addition, it is conceivable that the density of the material of the foreign body and/or the base material (= the material or the type of material which actually wants to be conveyed, e.g. harvested material etc.) of the material flow is determined by means of, in particular automatic, detection of the density by a measuring section and/or transport section. This can include the use of corresponding sensors along the measuring section. For this purpose, a time measurement can be carried out from which an average value can be derived. The average value can thus be an average density value of the foreign body material in the material flow and/or the material to be conveyed and can be stored in a database.

However, the above invention can not only be applied in the field of agricultural use, but can also find its application in other fields, such as the food industry. In this case, quality assurance can be carried out particularly easily by means of foreign object detection, for example in the filling of liquids and/or in the production of solid food. Furthermore, the application can also be used in the field of sorting systems.

Several radio frequencies and/or several radio frequency bands can also be used for detection. The radio frequencies and/or radio frequency bands can also be scanned one after the other or in groups. This makes it particularly easy to distinguish densities of foreign bodies and/or densities of base materials from each other. Foreign bodies of the same substance but different densities can also be distinguished from each other (grain, straw, etc.). In addition, a foreign body can be one which is not only made of the same material of different density, but of a different material. For example, the material flow of the agricultural commodity is formed by a stream of grain, with any metal splinters constituting such foreign bodies.

However, other foreign bodies in density, expansion, magnetism and/or dielectric value are also conceivable.

The device described here comprises at least one radiation transmitter which emits electromagnetic radiation, preferably in the microwave range.

The microwave range described here comprises a frequency range of at least one to 300 GHz, which corresponds to a wavelength of approximately 1 millimetre to 30 centimetres.

For example, the device described here is also applicable to the high-frequency measurement range. For this purpose, the radiation transmitter would emit electromagnetic radiation, preferably in the high frequency range. The frequency range extends from ultra high frequency (decimetre waves) to super high frequency (centimetre waves) to extremely high frequency (millimetre waves). This corresponds to frequencies from 300 MHz to 300 GHz. However, other frequency bands are equally conceivable.

Further, the device described herein comprises at least one radiation receiver for receiving at least a portion of the electromagnetic radiation emitted by the radiation transmitter.

The radiation receiver may be a radiation detector which detects the electromagnetic radiation.

Furthermore, the device described here comprises at least one detection module which converts the electromagnetic radiation impinging on the radiation receiver into image data, the image data being generated by an evaluation of amplitude, phase and/or frequency of the impinging electromagnetic radiation. For example, the image data is such data that is directly traceable to the amplitude, phase and/or frequency. For example, the image data comprises such data or data packets which have the triple of amplitude, phase and frequency, or at least information about this can be derived.

In at least one embodiment, the image data is transmitted to at least one transmission element, whereby the transmission element indicates the foreign bodies and/or the material inhomogeneities graphically, haptically, acoustically and/or numerically and/or identifies such foreign bodies and/or material inhomogeneities, preferably fully automatically, and/or authorises/controls/executes further measures.

In the present application, “identifying” can be understood as that process step which, on the basis of graphic representation means, first enables the user, for example the harvesting farmer, or machine technician, or machine inspector, or machine attendant, to determine the corresponding foreign bodies or material inhomogeneities and/or to track them along a path or a time axis. When tracking according to a time axis or a path axis, a corresponding transfer path can therefore be traced at corresponding time intervals against the corresponding time axis of a single foreign body or a whole group of foreign bodies. For example, after 0.5 seconds after start-up of the device, such a path of the foreign body or the entire group of foreign bodies is traced in a small, pictorially represented subwindow on a screen, with such an update being carried out in accordance with each newly starting time window. In this respect, a tracing of the individual foreign bodies within the material flow can even be ensured particularly easily.

In addition, it can be understood that the measured values determined by the detection module result in a sufficient change to the average density value of the material flow and that corresponding measures of the respective application are authorised or controlled. Furthermore, it is conceivable that the detection of foreign bodies and/or inhomogeneities of the material flow is carried out by a corresponding algorithm or by artificial intelligence.

Presented here is an inspection method for detecting foreign bodies and/or material inhomogeneities and/or on or in a production piece within a material flow of a consumable agricultural product, comprising the steps of providing a device for detecting foreign bodies and/or material inhomogeneities within a material flow of a consumable agricultural product, the device comprising at least one radiation transmitter emitting electromagnetic radiation, preferably in the microwave range, at least one radiation receiver for receiving at least a part of the electromagnetic radiation emitted by the radiation transmitter, and at least one detection module comprising the radiation transmitter and the detection module, at least one detection module which converts the electromagnetic radiation impinging on the radiation receiver into image data, in particular the image data being generated by evaluating the amplitude, phase and/or frequency of the impinging electromagnetic radiation, the image data being transmitted to a transmission element, the transmission element indicating the foreign bodies and/or the material inhomogeneities in a graphical, haptic, numerical and/or acoustic manner and/or identifying such foreign bodies and/or material inhomogeneities, preferably fully automatically, and/or authorising or itself triggering corresponding measures of the respective application.

However, the invention described here can also be applied outside of agricultural use. Conceivable here is an inspection of manufactured parts, such as an injection-moulded part/injection-moulded components or a cable sheathing. Also a detection, for example of a metal, further for example in a cable, can be carried out by means of the production. For this purpose, it is conceivable that metal and/or foreign body density measurements are then carried out by means of the method.

An evaluation, analysis and/or further processing of the data is possible by means of an evaluation device. This can be a light barrier. Transmitters and receivers can be positioned in relation to each other in the manner of a light barrier, frame light barrier, optical sensors, high-power light barriers, light curtains or combined in a housing as in a light barrier. For example, one or more transmitter-receiver pairs positioned on the machine can be used to localise the particles on or in the area of the machine and/or system.

In the field of automotive technology, an injection-moulded part could be inspected in one possible application to ensure that metal parts such as clips, nuts, washers, pins or other components that differ from the injection-moulded material have been inserted correctly or at all.

It is conceivable that an injection moulded part is guided by means of a conveyor belt and/or by means of a transport robot, in particular between a radiation transmitter and a radiation receiver.

The radiation receiver records variations in the density of the material. In doing so, the radiation receiver can count the metal parts via the density deviations that are thereby counted. This makes it possible to check whether the metal components have all been inserted in the injection-moulded part and whether it is therefore fully functional.

A general count of foreign bodies and/or grains is also possible with or without taking the density deviations into account. Rotten spots in vegetables and/or fruit and/or other food can also be detected via the density-moisture surface differences. In addition, the volume and/or size of the foreign bodies, material inhomogeneities, material flow, etc. can be recorded.

The material flow can also include a carrier flow, for example of air and/or water, in which material particles, such as grains, can be carried along, in particular entrained.

By means of the robot, it is conceivable that it moves to the production part between the two sensors and detects, for example, whether metal is present or not.

This makes it possible (in both variants, whether with conveyor belt or robot) to check whether the metal components or parts that differ from the injection moulding material in their physical factors and influence the electromagnetic waves have all been inserted in the injection moulded part and that it is therefore fully functional. Especially if it is no longer visually recognisable.

In addition, it can be envisaged that humidity in an ambient air is feasible by means of reflection (or alternatively or additionally by means of absorption alternatively or additionally by means of scattering) of radiation emitted by the radiation transmitter. The radiation transmitter and radiation receiver may be arranged on one side relative to the radiation path or on both sides thereof. A common circuit board may be provided for this purpose. Substances and/or materials can also be detected if they are located between the two sensors. Level measurements and temperature measurements are also possible. Without material excavation, pipelines, cables, water pipes or a drain in walls can also be detected, checked and/or displayed.

According to at least one embodiment, the values detected by the detection module are detected in real time, i.e. within at least one microsecond to at most 500 microseconds from detection by the radiation receiver.

The detection of the values can also be variably controlled. For this purpose, it is conceivable that the detection takes place on the basis of a controlled clock frequency, in particular direct request of the measurement/measured values and/or in predetermined time windows.

A periodic, clocked and/or continuous recording over an adjustable period of time can be selected under a variable recording of the values. In this context, an infinite transmission and/or reception is also conceivable. An interrogation of the measured values can be carried out in a predefinable manner in a temporal and/or local interrogation according to claim 1.

According to at least one embodiment, the acquisition module classifies the foreign bodies and/or material inhomogeneities from the acquired image data, so that the comparison of these image data with material and/or expansion and/or orientation data of the foreign bodies and/or material inhomogeneities and/or material/substances stored in a database comprises a classification procedure. Furthermore, it is also conceivable that the detection module can distinguish/identify/separate the foreign bodies from the material of the good flow by means of algorithms and/or artificial intelligence.

According to at least one embodiment, the device for detecting foreign bodies and/or material inhomogeneities within a material flow of a consumable agricultural product comprises at least one radiation transmitter which emits electromagnetic radiation, preferably in the microwave range, and at least one radiation receiver for receiving at least part of the electromagnetic radiation emitted by the radiation transmitter, and at least one detection module which converts the electromagnetic radiation impinging on the radiation receiver into image data, wherein the image data are generated by an evaluation of amplitude, phase and/or frequency of the incident electromagnetic radiation, wherein the image data can be transmitted to a transmission element, wherein the transmission element indicates the foreign bodies and/or the material inhomogeneities in a graphic, haptic, numeric and/or acoustic manner and/or identifies such foreign bodies and/or the material inhomogeneities, preferably fully automatically, and/or authorises or itself controls corresponding measures of the respective application.

The radiation can be detected by the radiation receiver by means of radiation reflection in the direction of the radiation transmitter. For this purpose, it is conceivable that the radiation transmitter and the radiation receiver are arranged on the same side relative to the material flow. For example, the radiation transmitter and radiation receiver are installed in the same housing and/or one and the same component.

Transmitter and receiver can be placed in a common housing, in particular the housing can be a pump housing, a motor housing, a gearbox housing, etc. The device can also detect small metal parts, such as metal filings or other abrasion products.

Small metal parts, such as metal filings, or other abrasion products can also be detected by means of the device described here. This suggests abrasion between two surfaces, at least one of which must be a metal, and suggests wear of the components/assemblies of machines and/or equipment.

According to at least one embodiment, the present invention is a machine and/or installation for processing a biodegradable product or a material contaminated by a substance, the substance differing in its physical properties affecting the electromagnetic waves and comprising at least one transport and/or packaging and/or processing element for transporting and/or processing a biodegradable product or a material contaminated by a substance, the substance differing in its physical properties affecting the electromagnetic waves. and in particular of an agricultural consumer product, at least one device for detecting foreign bodies and/or material inhomogeneities within a material flow of the biodegradable product or a material contaminated by a substance according to claim 4, wherein the device is mounted on the transport and/or processing element in such a way that the material flow can be examined for the foreign bodies and/or material inhomogeneities and/or on or in a production piece.

The agricultural machine can be a combine harvester. In addition, it is conceivable that the agricultural machine can be a chopper, wood chipper, automatic splitting machine, automatic saw splitting machine, harvester and sorting machine for vegetables and/or fruit. Other sorting or processing machines and plants, as well as machines not related to agricultural or forestry products or foodstuffs are also conceivable.

Both the agricultural machine described herein and the device described above can be operated by means of the method described above, so that all features disclosed for the method described herein are disclosed for both the device and the agricultural machine, and vice versa.

The transport and/or processing element described here can be any transport and/or processing element. For example, such a processing element is a chopper or other turning element or conveyor belt.

The transport and/or processing element may also comprise transport rollers, transport chutes or transport tubes, and/or a transport belt.

In the following, the invention described here is illustrated in more detail with the aid of a figure and the accompanying description.

In the figure, some parts may be shown excessively large, but this does not amount to a restrictive meaning.

In the FIGURE, it can be seen in a schematic perspective side view that the method 100 described there serves to detect foreign bodies and/or material inhomogeneities within a material flow of an agricultural consumer product.

Identifiable according to a method 100 presented herein are the steps of providing a device 200 for detecting foreign bodies and/or material inhomogeneities and/or on or in a production piece within a material flow of a consumable agricultural product, wherein the device 200 comprises at least one radiation transmitter 201 which emits electromagnetic radiation, preferably in the microwave range. In addition, a radiation receiver 202 for receiving at least part of the electromagnetic radiation emitted by the radiation transmitter 201 is identifiable, as well as a detection module 203 which converts the electromagnetic radiation impinging on the radiation receiver 202 into image data, the image data being generated by an evaluation of amplitude, phase and/or frequency of the impinging electromagnetic radiation. The image data are transmitted to a transmission element 400, wherein the transmission element 400 indicates the foreign bodies and/or the material inhomogeneities in a graphical, haptic, numerical and/or acoustic manner and/or identifies such foreign bodies and/or material inhomogeneities, preferably fully automatically, and/or authorises or itself triggers corresponding measures of the respective application case.

In this case, the detection module 203 detects the detected values in real time, i.e. within at least one microsecond to at most 500 microseconds from the detection by the radiation receiver 202.

In addition, the acquisition module 203 classifies the foreign bodies and/or material inhomogeneities from the material from the acquired image data, so that the comparison of this image data with material and/or expansion and/or orientation data of the foreign bodies and/or material inhomogeneities stored in a database comprises a classification procedure. Furthermore, it is also conceivable that the detection module can distinguish/determine/separate the foreign bodies from the material of the material flow using algorithms and/or artificial intelligence.

The method 100 described in the FIGURE is carried out by means of a device 200 for detecting foreign bodies and/or material inhomogeneities within a material flow of an agricultural commodity and/or the previously mentioned applications. It can be seen that a machine and/or plant 500 of the FIGURE comprises the device 200 described here, wherein the device 200 is arranged on a transport and/or processing element 501 on which the consumable is transported along a transport path. The corresponding consumable is guided between the radiation transmitter 201 and the radiation receiver 202 according to the FIGURE.

Such an intermediate passage of the consumable between the transmitter 201 and the receiver 202 is, independently of the FIGURE, generally also necessary for other embodiments.

### LIST OF REFERENCE SIGNS

100 Procedure
200 Device
201 Radiation transmitter
202 Radiation receiver
203 Detection module
400 Transmission element
500 Machine and/or installation
501 Transport and/or processing element

1. Method (100) for detecting foreign bodies and/or material inhomogeneities within a material flow and/or on or in a production piece, in particular a biodegradable product or a material contaminated by a substance, comprising the steps of
Providing a device (200) for detecting foreign bodies and/or material inhomogeneities and/or on or in a production piece within a material flow of a biodegradable product or a material contaminated by a substance, wherein the substance and/or material differs by its physical properties which influence the electromagnetic waves and the device comprises
at least one radiation emitter (201) emitting electromagnetic radiation, preferably in the microwave range
at least one radiation receiver (202) for receiving at least a part of the electromagnetic radiation emitted by the radiation transmitter (201)
at least one detection module (203) which converts the electromagnetic radiation impinging on the radiation receiver (202) into image data, the image data being generated by an evaluation of amplitude, phase and/or frequency of the impinging electromagnetic radiation, characterized in that
the image data are transmitted to a transmission element (400) in a clocked or variably requested manner, wherein the transmission element (400) indicates the foreign bodies and/or the material inhomogeneities in a graphic, haptic and/or acoustic and/or numerical manner and/or identifies such foreign bodies and/or the material inhomogeneities, preferably fully automatically, and/or authorises or itself controls corresponding measures of the respective application case.

2. Method (100) according to claim 1,
characterized in that
the values detected by the detection module (203) are detected in real time, i.e. within at least one microsecond to at most 500 microseconds from the detection by the radiation receiver (202), or can be detected by a variable measured value request or a clocked output.

3. Method (100) according to claim 2,
characterized in that
the detection module (203) classifies the foreign bodies and/or material inhomogeneities from the material from the detected image data, so that the comparison of these image data with material and/or expansion and/or orientation data of the foreign bodies and/or material inhomogeneities stored in a database comprises a classification procedure and/or the detection module can distinguish/determine/separate the foreign bodies from the material of the material flow by algorithms and/or artificial intelligence.

4. Device (200) for detecting foreign bodies and/or material inhomogeneities and/or on or in a production piece within a material flow of a biodegradable product or a material contaminated by a substance, said device comprising
a. at least one radiation emitter (201) which emits electromagnetic radiation, preferably in the microwave range
b. at least one radiation receiver (202) for receiving at least a part of the electromagnetic radiation emitted by the radiation transmitter (201),
c. at least one detection module (203) which converts the electromagnetic radiation impinging on the radiation receiver (202) into image data, the image data being generated by evaluating the amplitude, phase and/or frequency of the impinging electromagnetic radiation, characterised in that
the image data can be transmitted to a transmission element (400) in a clocked or variably requested manner, wherein the transmission element (400) indicates in a graphic, haptic and/or acoustic and/or numerical manner the foreign bodies and/or the material inhomogeneities and/or on or in a finished article and/or identifies such, preferably fully automatically, and/or authorises or itself controls corresponding measures of the respective application.

5. Machine and/or plant (500) for processing a biodegradable product or a material contaminated by a substance, comprising
at least one transport and/or processing element (501) for transporting and/or processing a biodegradable product or a material contaminated by a substance,
at least one device (200) for detecting foreign bodies and/or material inhomogeneities within a material flow of the biodegradable product or a material contaminated by a substance according to claim 4, wherein
the device (200) is mounted on the transport and/or processing element (501) in such a way that the material flow can be examined for the foreign bodies and/or material inhomogeneities and/or on or in a production piece.
